(19) United States
(12) Patent Application Publication
(10) Pub. No.: US 2020/0065694 A1
(43) Pub. Date: Feb. 27, 2020

(54) METHOD AND SYSTEM FOR ANALYZING AND PREDICTING GEOGRAPHIC HABITS

(71) Applicant: Facebook, Inc., Menlo Park, CA (US)

(72) Inventors: Saurav Mohapatra, Lexington, MA (US); Vladimir Leonid Bychkovsky, Cambridge, MA (US); Rohit Garg, Jersey City, NJ (US); Mostafa Keikha, Watertown, MA (US)

(21) Appl. No.: 16/107,686

(22) Filed: Aug. 21, 2018

(51) Int. Cl. G06N 7/00; G06F 17/30; G06Q 30/02; G06Q 50/00

(52) U.S. Cl. CPC G06N 7/005; G06F 17/30241; G06Q 30/0261; G06Q 30/0254; G06Q 30/0259; G06Q 50/01; G06Q 30/0267

(57) ABSTRACT

A method includes receiving location reports indicating locations of mobile devices associated with users of an internet platform, registering a count for each location report, determining, for each location report received from a mobile device, a recent location report received from the mobile device indicating a previous location and registering a transition for each of a paired location report and recent location report, corresponding to a pair of locations. The method includes counting a number of transitions corresponding to a particular pair of locations and determining common transitions by comparing the number of transitions to a threshold value. The method includes comparing a location report received from a user's mobile device with location reports included in common transitions, and predicting, based on the comparison, a likelihood the user will arrive at a particular place within a particular time period or a likelihood that the user was at a particular place within a particular time before the current time.

### TECHNICAL FIELD

This disclosure generally relates to the analysis and prediction of the geographic habits of users of a social network.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Particular embodiments of this disclosure provide a method and system for anonymously collecting spatio-temporal location data from mobile devices located within one or more defined regions, as well as information regarding movement by such mobile devices from region to region. In particular embodiments, such regions may correspond to cells of a grid associated with a geographic region. Using such data, particular embodiments may include, but are not limited to determining which regions tend to be heavily or lightly populated, identifying heavily traversed routes, predicting where a user associated with a mobile device in a particular region may be going, or determining where the user associated with the mobile device currently detected as being in a particular region may have recently been.

Systems and methods described herein may be employed for a number of uses, including but not limited to customizing content or advertisements for suggestion to the user or delivery to the mobile device, providing other location/route-related recommendations to a user, and providing safety information to users of a social-networking system. In some embodiments, user permission for such anonymous collection of location data is requested from the user, and without confirmation of such user permission, no location data will be collected—anonymously or otherwise. In particular embodiments, user permission may be separately requested for different uses of the location data, wherein user permission may be granted for certain uses and not others. In particular embodiments, user permission for collection of location data from a particular mobile device may be re-requested upon detection of certain events (e.g., login by a different user to an operating system of the mobile device or to one or more applications installed on the mobile device, or detection that the mobile device has traveled to a location with different restrictions upon collection and/or use of location data).

Particular embodiments may predict a likelihood that a user will visit a particular place, based on location data provided by the user's mobile device. In some embodiments, select content, advertisements, or other data may be sent to a user's mobile device based on the prediction.

Using such anonymous data regarding the collective geographic habits of a population, particular embodiments may include predicting, based on current location data associated with a specific user's mobile device, a region where the user may visit within a certain period of time. The predicted region may be represented by longitude and latitude coordinates, and may also be associated with various places, such as particular buildings, schools, stores, restaurants, transportation systems, or landmarks.

In another embodiment, the method or system may identify, based on current location data associated with the user's mobile device, a region where the user may have recently visited. In one embodiment, the system or method may track habitual patterns that users travel over a period of time. For example, a server may determine that most users who visit a particular restaurant will then visit a particular theater to enjoy an event, such as a movie or a performance event. In particular embodiments, the system or method may compute a confidence score for such predictions, identifications, and/or determinations.

In another embodiment, the system may determine periodic patterns. For example, the server may determine based on location data received from a user's mobile device at certain times that the user will visit the mall two days before Christmas or will visit a particular place on their birthday.

In particular embodiments, a server may poll a mobile device by sending a request for a location report to the mobile device, wherein the location report may include location data such as: information identifying a current location of the mobile device (e.g., a GPS latitude and longitude), a timestamp of the location report, and device information (e.g., device type, software version, cell service provider). Such polling of a mobile device may be done on a periodic basis. Location data may also include data related to grid cells associated with certain geographic regions. In particular embodiments, the mobile device may simply transmit location reports on a periodic basis on its own, as opposed to only sending the location in response to a request from a server.

In particular embodiments, the periodic basis may shift to take place at shorter intervals (e.g., when the mobile device is moving continuously or is accelerating in speed) or at longer intervals (e.g., when the mobile device is only moving intermittently or at a low speed). In particular embodiments, transmission of location reports may be temporarily paused (e.g., when the mobile device is not moving, when the mobile device is low on battery power, or when network connectivity is poor or costly).

In particular embodiments, a method may include, by a computing system, receiving location reports over a specified period of time indicating locations of mobile devices associated with users of an online platform, and registering a count for each location report received from a mobile device indicating a location of the mobile device. The method may also include determining, for each location report received from a mobile device, a recent location report received from the mobile device indicating a previous location of the mobile device. The method may include registering a transition with respect to a pair of location reports (corresponding to a pair of locations), counting a number of transitions between the pair of locations, and determining common transitions by comparing the number of transitions corresponding to the pair of locations to a threshold value. The method may include receiving a location report indicating the current location of a subject user's mobile device, comparing the location report indicating the current location of the subject user's mobile device with location reports included in common transitions, and predicting, based on a comparison between the location report indicating the current location of the subject user's mobile device and the location reports included in at least one common transition, a likelihood that the subject user will arrive at a particular place within a particular time period or a likelihood that the subject user was at a particular place within a particular time period before the current time.

In particular embodiments, a system may include a receiver configured to receive location reports over a specified period of time indicating locations of mobile devices associated with users of an internet platform. The system may also include a processor, coupled to the receiver, configured to register a count for each location report received from a mobile device indicating a location of the mobile device. The system may determine, for each location report received from a mobile device, a recent location report received from the mobile device indicating a previous location of the mobile device. The system may register a transition with respect to a pair of location reports (corresponding to a pair of locations) and count a number of transitions corresponding to the pair of locations. The system may also include the processor being configured to determine common transitions by comparing the number of transitions corresponding to the pair of locations to a threshold value. The system may also include the receiver being further configured to receive a location report indicating the current location of a subject user's mobile device. The system may include the processor being further configured to compare the location report indicating the current location of the subject user's mobile device with location reports included in common transitions and to predict, based on a comparison between the location report indicating the current location of the subject user's mobile device and the location reports included in at least one common transition, a likelihood that the subject user will arrive at a particular place within a particular time period or a likelihood that the subject user was at a particular place within a particular time period before the current time.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, may be claimed in another claim category, e.g. system, as well. The dependencies or references back in the attached claims are chosen for formal reasons only. However, any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

### BRIEF DESCRIPTION OF THE DRAWINGS

FIG. 1 illustrates exemplary embodiments of this disclosure.

FIG. 2 illustrates an example method for analyzing and predicting geographic habits.

FIG. 3 illustrates an example network environment associated with a social-networking system.

FIG. 4 illustrates an example social graph.

FIG. 5 illustrates an example computer system.

### DESCRIPTION OF EXAMPLE EMBODIMENTS

This disclosure relates to systems and methods for predicting geographic habits. The methods and systems disclosed herein may be applied, for example, in the context of predicting the habits of users of a social-networking system or website, based on data received from mobile devices associated with those users.

As described herein, location data may include a wide variety of data, including but certainly not limited to longitude, latitude, and timestamp data. Such data may also include place names, such as the names of businesses, street addresses, schools, landmarks, or transportation systems.

In some embodiments, the methods and systems disclosed may be used to determine an advertisement of relevance to the subject user and to communicate that advertisement to the subject user. The method may determine the relevance of the advertisement to the subject user based on the predicted likelihood that the subject user will arrive at a particular place within a particular time period, the advertisement being relevant to the particular place.

In some embodiments, the methods and systems disclosed may be used to determine other information of relevance to the subject user and communicate that information to the subject user. The information may be determined to be of relevance to the subject user based on the predicted likelihood that the subject user will arrive at a particular place within a particular time period, the information being relevant to the particular place. The method may include determining such information about places where a user is predicted to arrive within a particular time period and communicating that information to the subject user. For example, and not limitation, such information may be safety information regarding the location that the user is predicted to visit within a particular time period. Such safety information may include, for example, a notification that the particular place is experiencing an unsafe condition of some kind. Such safety information would be relevant to a subject user who is predicted to travel to that particular place, and so that information may be communicated to the subject user by the methods and systems disclosed herein.

In some embodiments, the methods and systems disclosed may predict one or more periodic patterns. A periodic pattern may be a common transition that occurs with a certain frequency or on a certain schedule. For example, and not limitation, a periodic pattern may indicate that a subject user at a particular place and time will travel to a second particular place within a certain period of time, based not only on the subject user's location at the present time, but also based on the present time itself. So, for example, a periodic pattern might indicate that users in or near a particular city have a likelihood of going to the mall two days before Christmas. A user located in or near that city might be predicted to adhere to that periodic pattern based on their location in or near that city, or in a particular part of that city, on December 23^{rd}. In particular embodiments, a pattern may be predicted based on time of day, day of the week, day of the year, dates of holidays, events (e.g., sporting events, concerts, conferences, political rallies, funerals, school graduation ceremonies) that are located nearby or may affect environmental conditions nearby, weather reports, incident reports (e.g., issued by law enforcement, a government agency, or by a neighborhood association or professional association), major construction, a change in laws affecting local traffic or pedestrian walkways, or any other non-user-specific factor.

In particular embodiments, prediction of a periodic pattern may also vary based on demographic factors, such as, by way of example and not limitation, age, sex, or disability, as well as other user-specific factors, such as whether the user has access to a particular type of vehicle (e.g., bicycle or automobile), the user's typical work schedule, and the user's lifestyle and/or hobbies.

Periodic patterns may also be based on patterns of an individual user. For example, a user might visit their hometown several times every year. When that user's mobile device is recorded as within a certain geographic region that happens to be associated with the user's hometown, the user's mobile device might also tend to send location data associated with a particular restaurant. The system may record this location data and record a common transition including location reports from that user's mobile device of locations associated with the user's hometown and location reports from that user's mobile device associated with the particular restaurant. Applying this periodic pattern, the method and system may determine advertisements relevant to the restaurant and may communicate those advertisements to the user's mobile device. For example, when a location report is received from the user's mobile device with location data associated with the geographic area that happens to be within the user's hometown, an advertisement relevant to the restaurant may be communicated to the user's mobile device.

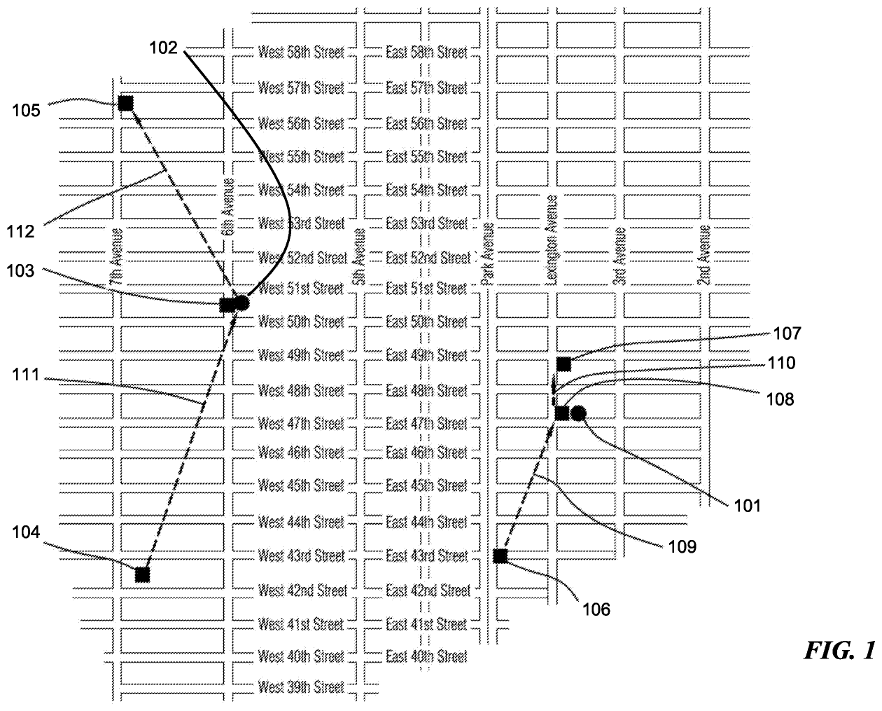

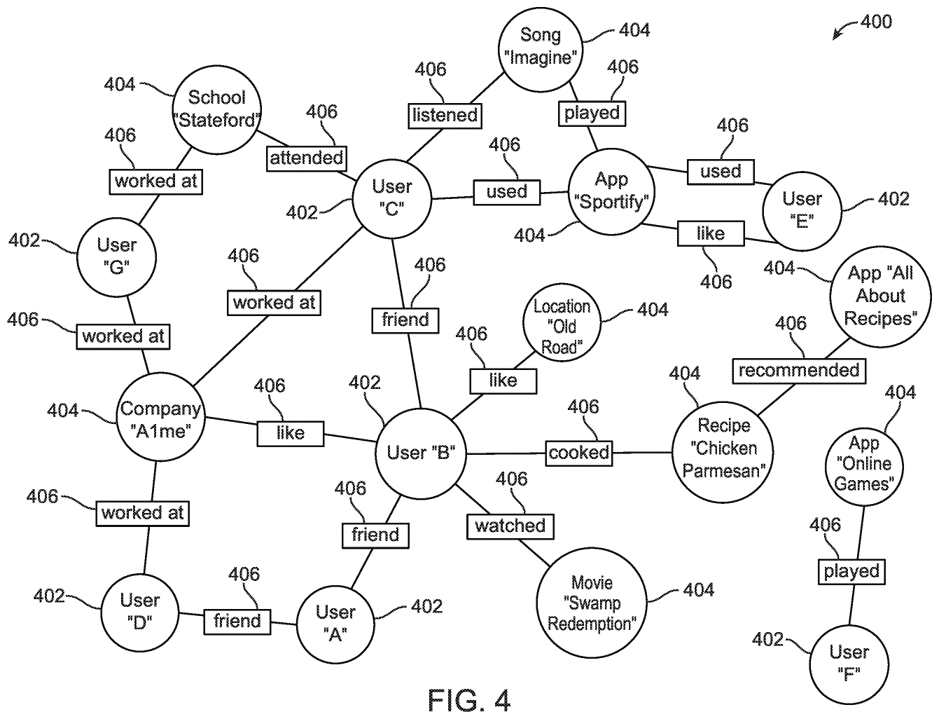

FIG. 1 illustrates exemplary embodiments of this disclosure, including two examples according to the method steps disclosed in FIG. 4 infra. In one exemplary embodiment, a location report 101 may be received, for example, from a “commuter” subject user indicating that the user is located at or near a coffee shop 108. The disclosed method and system may compare location report 101 to location reports included in common transitions. For example, one common transition 110 may be based on pairing location reports at the approximate location of location report 101 with location reports later received from users' mobile devices located at or near big office building 107. Accordingly, the method or system could predict to a certain likelihood, that the “commuter” will travel, within a certain period of time also associated with common transition 110, to big office building 107 from coffee shop 108.

Location report 101 may include latitude, longitude, and a timestamp. In addition or alternatively, location report 101 may include the business name of one or more nearby business, or the business with which the location data of the location report 101 is most closely related. In addition or alternatively, location report 101 may include the identification of a cell tower coverage area or a grid cell associated with a certain geographic area. The “commuter” user is identified as a typical commuter for example purposes only, and in practice the method need not classify users by any type or by any habits other than those identified by analyzing location data.

Based on the prediction that there is a likelihood that the subject user “commuter” will travel from coffee shop 108 to big office building 107, the computer system employing the disclosed method or system may determine whether there is information pertaining to big office building 107 that might be relevant to the user and may communicate such notification to the subject user commuter.

Common transition 109 may also represent a common transition including location reports that originate from the approximate location of location report 101. Common transition 109 may be based on pairing location reports in the approximate location of location report 101 with location reports in the approximate location of transportation hub 106. the method or system, having received and registered counts for location reports from users' mobile devices at or near transportation hub 106 and then, at a certain time later, having received and registered counts for location reports from users' mobile devices at or near coffee shop 108, may determine that this pairing represents a common transition. Based on that common transition, the method or system may predict a likelihood that the subject user “commuter” was at transportation hub 106 within a particular time period prior to the time that location report 101 was received.

In a similar exemplary embodiment, “tourist” location report 102 may be received by the computer system employing the disclosed method or system. As in the example above related to the “commuter” user, the method or system may determine, based on the receipt of the subject user tourist's mobile device's location report indicating the subject user tourist's location at Landmark A 103 and the comparison of that location report to location reports included in an established common transition 112 including Landmark B 105, that the subject user has a likelihood of traveling to Landmark B 105 within a particular period of time. Accordingly, the method and system may include determining an advertisement of relevance to Landmark B 105 and communicating that advertisement to the mobile device of the subject user tourist.

In some embodiments, the advertisement may be communicated in a time frame such that the user might receive it before arriving at the particular location and in other embodiments, the advertisement may be communicated in a different time frame. For example, the advertisement may be communicated once the subject user has arrived at the particular location to which the advertisement is relevant, or after the subject user has departed the particular location. Such timing of the communication of advertisements might, for example, be planned to persuade the subject user to buy a certain product when they arrive at a particular location, or to stay at a particular location for a certain period of time, or to persuade the subject user to return to the particular location another time.

In one embodiment, a determined common transition may include a periodic pattern. With reference to FIG. 1, a periodic pattern could include, for example, common transition 111, comprising pairs of location reports including the locations of landmark A 103 and landmark B 104. Both being landmarks, landmark A 103 and landmark B 104 could be connected by common transition 111 only (or only most commonly) during certain days of the year, for example, the days surrounding January 1^{st}. Therefore, in such a case a subject user “tourist” location report 102 might result in a prediction of high likelihood that the subject user was located at Landmark B 104 within a particular time period before the receipt of location report 102.

For the purposes of example and clarity, exemplary embodiments of the disclosed methods and systems have been described with reference to location reports 101 and 103, and common transitions 109, 110, 111, and 112. However, in the context of the disclosed methods and systems, numerous location reports may be received in even a short period of time from many users within a given geographical region. Similarly, location reports may be compared to many common transitions generated by the disclosed methods and systems that may include the location reports received by the disclosed methods and systems, and the disclosed methods and systems may use more than one common transition to make the disclosed predictions.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

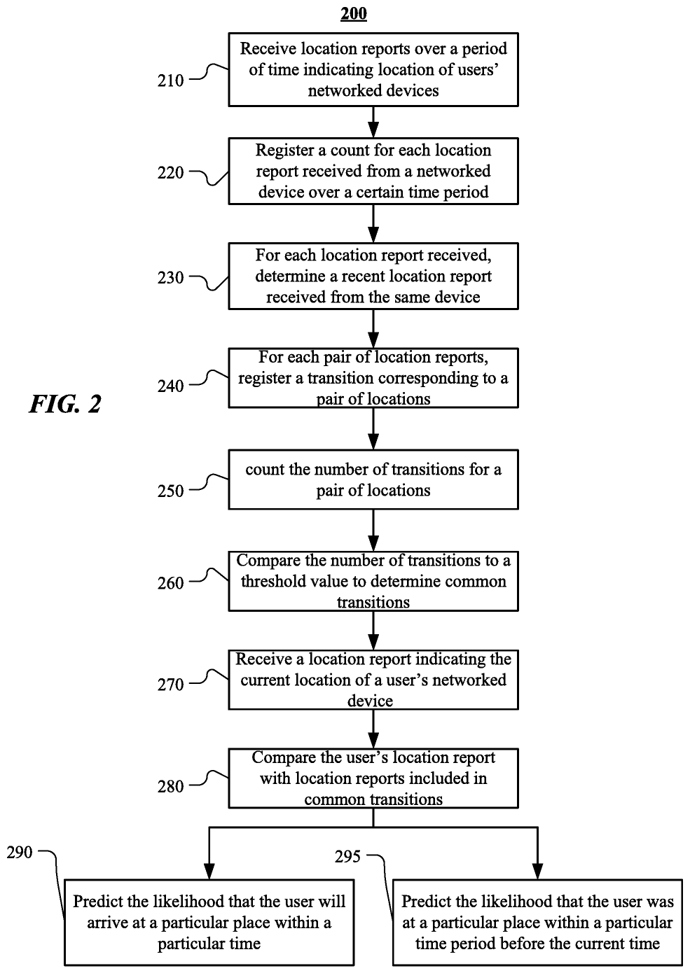

FIG. 2 illustrates an example method 200 for predicting geographic habits. The method may begin at step 210, where a computer system may receive location reports over a period of time indicating the location of mobile devices associated with users of a social-networking system or website. At step 220, the method may include registering a count for each location report received from a mobile device over a certain time period. At step 230, a recent location report that was received from the same device may be determined for each location report that is received. At step 240, a transition may be registered corresponding to a pair of location reports. At step 250, the number of transitions corresponding to a particular pair of locations may be counted. At step 260, the number of transitions corresponding to a particular pair of locations may be compared to a threshold value and common transitions may be determined. At step 270, a location report from a subject user's mobile device may be received by the computer system. At step 280, the location report received from the subject user's mobile device may be compared with location reports included in common transitions. At step 290, the system may predict the likelihood that the subject user will arrive at a particular place within a particular time. In addition to the prediction at step 290, or alternatively, at step 295, the system may, based on the location report received from the subject user indicating the subject user's current location, predict the likelihood that the subject user was at a particular place within a particular time period before the current time. In comparing the location report associated with the subject user's current location with location reports included in common transitions, example method 200 may seek to match the subject user's current location report with second paired location reports, i.e., location reports occurring second within common transitions, as opposed to first paired location reports, i.e. location reports occurring earlier in time within common transitions. In this manner, the example method 200 may use common transitions to determine where a user has been within a prior time period as opposed to where the user will be at a later time.

Particular embodiments may repeat one or more steps of the methods of FIG. 2 where appropriate. Although this disclosure describes and illustrates particular steps of the methods of FIG. 2 as occurring in a particular order, this disclosure contemplates any suitable steps of the methods of FIG. 2 occurring in any suitable order. Moreover, although this disclosure describes and illustrates example methods for predicting geographic habits including the particular steps of the methods of FIG. 2, this disclosure contemplates any suitable methods for predicting geographic habits including any suitable steps, which may include all, some, or none of the steps of the methods of FIG. 2, where appropriate. Furthermore, although this disclosure describes and illustrates particular components, devices, or systems carrying out particular steps of the methods of FIG. 2, this disclosure contemplates any suitable combination of any suitable components, devices, or systems carrying out any suitable steps of the methods of FIG. 2.

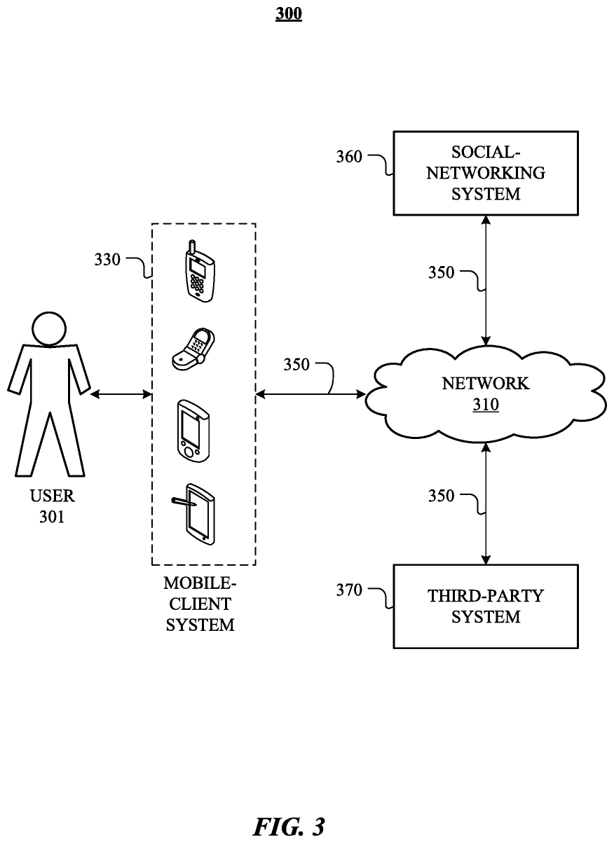

FIG. 3 illustrates an example network environment 300 associated with a social-networking system. Network environment 300 includes a user 301, a client system 330, a social-networking system 360, and a third-party system 370 connected to each other by a network 310. Although FIG. 3 illustrates a particular arrangement of user 301, client system 330, social-networking system 360, third-party system 370, and network 310, this disclosure contemplates any suitable arrangement of user 301, client system 330, social-networking system 360, third-party system 370, and network 310. As an example and not by way of limitation, two or more of client system 330, social-networking system 360, and third-party system 370 may be connected to each other directly, bypassing network 310. As another example, two or more of client system 330, social-networking system 360, and third-party system 370 may be physically or logically co-located with each other in whole or in part. Moreover, although FIG. 3 illustrates a particular number of users 301, client systems 330, social-networking systems 360, third-party systems 370, and networks 310, this disclosure contemplates any suitable number of users 301, client systems 330, social-networking systems 360, third-party systems 370, and networks 310. As an example and not by way of limitation, network environment 300 may include multiple users 301, client system 330, social-networking systems 360, third-party systems 370, and networks 310.

In particular embodiments, user 301 may be an individual (human user), an entity (e.g., an enterprise, business, or third-party application), or a group (e.g., of individuals or entities) that interacts or communicates with or over social-networking system 360. In particular embodiments, social-networking system 360 may be a network-addressable computing system hosting an online social network. Social-networking system 360 may generate, store, receive, and send social-networking data, such as, for example, user-profile data, concept-profile data, social-graph information, or other suitable data related to the online social network. Social-networking system 360 may be accessed by the other components of network environment 300 either directly or via network 310. In particular embodiments, social-networking system 360 may include an authorization server (or other suitable component(s)) that allows users 301 to opt in to or opt out of having their actions logged by social-networking system 360 or shared with other systems (e.g., third-party systems 370), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 360 through blocking, data hashing, anonymization, or other suitable techniques as appropriate. In particular embodiments, third-party system 370 may be a network-addressable computing system that can host a third-party website. Third-party system 370 may generate, store, receive, and send data associated with a third-party website, such as, for example, advertisements, links, and images. Third-party system 370 may be accessed by the other components of network environment 300 either directly or via network 310. In particular embodiments, one or more users 301 may use one or more client systems 330 to access, send data to, and receive data from social-networking system 360 or third-party system 370. Client system 330 may access social-networking system 360 or third-party system 370 directly, via network 310, or via a third-party system. As an example and not by way of limitation, client system 330 may access third-party system 370 via social-networking system 360. Client system 330 may be any suitable computing device, such as, for example, a personal computer, a laptop computer, a cellular telephone, a smartphone, a tablet computer, or an augmented/virtual reality device.

This disclosure contemplates any suitable network 310. As an example and not by way of limitation, one or more portions of network 310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 310 may include one or more networks 310.

Links 350 may connect client system 330, social-networking system 360, and third-party system 370 to communication network 310 or to each other. This disclosure contemplates any suitable links 350. In particular embodiments, one or more links 350 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 350, or a combination of two or more such links 350. Links 350 need not necessarily be the same throughout network environment 300. One or more first links 350 may differ in one or more respects from one or more second links 350.

FIG. 4 illustrates example social graph 400. In particular embodiments, social-networking system 360 may store one or more social graphs 400 in one or more data stores. In particular embodiments, social graph 400 may include multiple nodes—which may include multiple user nodes 402 or multiple concept nodes 404—and multiple edges 406 connecting the nodes. Example social graph 400 illustrated in FIG. 4 is shown, for didactic purposes, in a two-dimensional visual map representation. In particular embodiments, a social-networking system 360, client system 330, or third-party system 370 may access social graph 400 and related social-graph information for suitable applications. The nodes and edges of social graph 400 may be stored as data objects, for example, in a data store (such as a social-graph database). Such a data store may include one or more searchable or queryable indexes of nodes or edges of social graph 400.

In particular embodiments, a user node 402 may correspond to a user of social-networking system 360. As an example and not by way of limitation, a user may be an individual (human user), an entity (e.g., an enterprise, business, or third-party application), or a group (e.g., of individuals or entities) that interacts or communicates with or over social-networking system 360. In particular embodiments, when a user registers for an account with social-networking system 360, social-networking system 360 may create a user node 402 corresponding to the user and store the user node 402 in one or more data stores. Users and user nodes 402 described herein may, where appropriate, refer to registered users and user nodes 402 associated with registered users. In addition or as an alternative, users and user nodes 402 described herein may, where appropriate, refer to users that have not registered with social-networking system 360. In particular embodiments, a user node 402 may be associated with information provided by a user or information gathered by various systems, including social-networking system 360. As an example and not by way of limitation, a user may provide his or her name, profile picture, contact information, birth date, sex, marital status, family status, employment, education background, preferences, interests, or other demographic information. In particular embodiments, a user node 402 may be associated with one or more data objects corresponding to information associated with a user. In particular embodiments, a user node 402 may correspond to one or more webpages.

In particular embodiments, a concept node 404 may correspond to a concept. As an example and not by way of limitation, a concept may correspond to a place (such as, for example, a movie theater, restaurant, landmark, or city); a website (such as, for example, a website associated with social-network system 360 or a third-party website associated with a web-application server); an entity (such as, for example, a person, business, group, sports team, or celebrity); a resource (such as, for example, an audio file, video file, digital photo, text file, structured document, or application) which may be located within social-networking system 360 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 404 may be associated with information of a concept provided by a user or information gathered by various systems, including social-networking system 360. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 404 may be associated with one or more data objects corresponding to information associated with concept node 404. In particular embodiments, a concept node 404 may correspond to one or more webpages.

In particular embodiments, a node in social graph 400 may represent or be represented by a webpage (which may be referred to as a “profile page”). Profile pages may be hosted by or accessible to social-networking system 360. Profile pages may also be hosted on third-party websites associated with a third-party system 370. As an example and not by way of limitation, a profile page corresponding to a particular external webpage may be the particular external webpage and the profile page may correspond to a particular concept node 404. Profile pages may be viewable by all or a selected subset of other users. As an example and not by way of limitation, a user node 402 may have a corresponding user-profile page in which the corresponding user may add content, make declarations, or otherwise express himself or herself. As another example and not by way of limitation, a concept node 404 may have a corresponding concept-profile page in which one or more users may add content, make declarations, or express themselves, particularly in relation to the concept corresponding to concept node 404.

In particular embodiments, a concept node 404 may represent a third-party webpage or resource hosted by a third-party system 370. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 330 to send to social-networking system 360 a message indicating the user's action. In response to the message, social-networking system 360 may create an edge (e.g., a check-in-type edge) between a user node 402 corresponding to the user and a concept node 404 corresponding to the third-party webpage or resource and store edge 406 in one or more data stores.

In particular embodiments, a pair of nodes in social graph 400 may be connected to each other by one or more edges 406. An edge 406 connecting a pair of nodes may represent a relationship between the pair of nodes. In particular embodiments, an edge 406 may include or represent one or more data objects or attributes corresponding to the relationship between a pair of nodes. As an example and not by way of limitation, a first user may indicate that a second user is a “friend” of the first user. In response to this indication, social-networking system 360 may send a “friend request” to the second user. If the second user confirms the “friend request,” social-networking system 360 may create an edge 406 connecting the first user's user node 402 to the second user's user node 402 in social graph 400 and store edge 406 as social-graph information in one or more of data stores 364. In the example of FIG. 4, social graph 400 includes an edge 406 indicating a friend relation between user nodes 402 of user “A” and user “B” and an edge indicating a friend relation between user nodes 402 of user “C” and user “B.” Although this disclosure describes or illustrates particular edges 406 with particular attributes connecting particular user nodes 402, this disclosure contemplates any suitable edges 406 with any suitable attributes connecting user nodes 402. As an example and not by way of limitation, an edge 406 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 400 by one or more edges 406. The degree of separation between two objects represented by two nodes, respectively, is a count of edges in a shortest path connecting the two nodes in the social graph 400. As an example and not by way of limitation, in the social graph 400, the user node 402 of user “C” is connected to the user node 402 of user “A” via multiple paths including, for example, a first path directly passing through the user node 402 of user “B,” a second path passing through the concept node 404 of company “Acme” and the user node 402 of user “D,” and a third path passing through the user nodes 402 and concept nodes 404 representing school “Stanford,” user “G,” company “Acme,” and user “D.” User “C” and user “A” have a degree of separation of two because the shortest path connecting their corresponding nodes (i.e., the first path) includes two edges 406.

In particular embodiments, an edge 406 between a user node 402 and a concept node 404 may represent a particular action or activity performed by a user associated with user node 402 toward a concept associated with a concept node 404. As an example and not by way of limitation, as illustrated in FIG. 4, a user may “like,” “attended,” “played,” “listened,” “cooked,” “worked at,” or “watched” a concept, each of which may correspond to an edge type or subtype. A concept-profile page corresponding to a concept node 404 may include, for example, a selectable “check in” icon (such as, for example, a clickable “check in” icon) or a selectable “add to favorites” icon. Similarly, after a user clicks these icons, social-networking system 360 may create a “favorite” edge or a “check in” edge in response to a user's action corresponding to a respective action. As another example and not by way of limitation, a user (user “C”) may listen to a particular song (“Imagine”) using a particular application (an online music application). In this case, social-networking system 360 may create a “listened” edge 406 and a “used” edge (as illustrated in FIG. 4) between user nodes 402 corresponding to the user and concept nodes 404 corresponding to the song and application to indicate that the user listened to the song and used the application. Moreover, social-networking system 360 may create a “played” edge 406 (as illustrated in FIG. 4) between concept nodes 404 corresponding to the song and the application to indicate that the particular song was played by the particular application. In this case, “played” edge 406 corresponds to an action performed by an external application on an external audio file (the song “Imagine”). Although this disclosure describes particular edges 406 with particular attributes connecting user nodes 402 and concept nodes 404, this disclosure contemplates any suitable edges 406 with any suitable attributes connecting user nodes 402 and concept nodes 404. Moreover, although this disclosure describes edges between a user node 402 and a concept node 404 representing a single relationship, this disclosure contemplates edges between a user node 402 and a concept node 404 representing one or more relationships. As an example and not by way of limitation, an edge 406 may represent both that a user likes and has used at a particular concept. Alternatively, another edge 406 may represent each type of relationship (or multiples of a single relationship) between a user node 402 and a concept node 404 (as illustrated in FIG. 4 between user node 402 for user “E” and concept node 404).

In particular embodiments, social-networking system 360 may create an edge 406 between a user node 402 and a concept node 404 in social graph 400. As an example and not by way of limitation, a user viewing a concept-profile page (such as, for example, by using a web browser or a special-purpose application hosted by the user's client system 330) may indicate that he or she likes the concept represented by the concept node 404 by clicking or selecting a “Like” icon, which may cause the user's client system 330 to send to social-networking system 360 a message indicating the user's liking of the concept associated with the concept-profile page. In response to the message, social-networking system 360 may create an edge 406 between user node 402 associated with the user and concept node 404, as illustrated by “like” edge 406 between the user and concept node 404. In particular embodiments, social-networking system 360 may store an edge 406 in one or more data stores. In particular embodiments, an edge 406 may be automatically formed by social-networking system 360 in response to a particular user action. As an example and not by way of limitation, if a first user uploads a picture, watches a movie, or listens to a song, an edge 406 may be formed between user node 402 corresponding to the first user and concept nodes 404 corresponding to those concepts. Although this disclosure describes forming particular edges 406 in particular manners, this disclosure contemplates forming any suitable edges 406 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 360). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 360 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 360) or RSVP (e.g., through social-networking system 360) to an event associated with the advertisement. In addition or as an alternative, an advertisement may include social-networking-system content directed to the user. As an example and not by way of limitation, an advertisement may display information about a friend of the user within social-networking system 360 who has taken an action associated with the subject matter of the advertisement.

In particular embodiments, social-networking system 360 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 370 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 360 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 360 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 360 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 360 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 360 may calculate a coefficient based on a user's actions. Social-networking system 360 may monitor such actions on the online social network, on a third-party system 370, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 360 may calculate a coefficient based on the user's actions with particular types of content. The content may be associated with the online social network, a third-party system 370, or another suitable system. The content may include users, profile pages, posts, news stories, headlines, instant messages, chat room conversations, emails, advertisements, pictures, video, music, other suitable objects, or any combination thereof. Social-networking system 360 may analyze a user's actions to determine whether one or more of the actions indicate an affinity for subject matter, content, other users, and so forth. As an example and not by way of limitation, if a user frequently posts content related to “coffee” or variants thereof, social-networking system 360 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 360 may calculate a coefficient based on the type of relationship between particular objects. Referencing the social graph 400, social-networking system 360 may analyze the number and/or type of edges 406 connecting particular user nodes 402 and concept nodes 404 when calculating a coefficient. As an example and not by way of limitation, user nodes 402 that are connected by a spouse-type edge (representing that the two users are married) may be assigned a higher coefficient than user nodes 402 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 360 may determine that the user has a higher coefficient with respect to the first photo than the second photo because having a tagged-in-type relationship with content may be assigned a higher weight and/or rating than having a like-type relationship with content. In particular embodiments, social-networking system 360 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 360 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 400. As an example and not by way of limitation, social-graph entities that are closer in the social graph 400 (i.e., fewer degrees of separation) may have a higher coefficient than entities that are further apart in the social graph 400.

In particular embodiments, social-networking system 360 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 330 of the user). A first user may be more interested in other users or concepts that are closer to the first user. As an example and not by way of limitation, if a user is one mile from an airport and two miles from a gas station, social-networking system 360 may determine that the user has a higher coefficient for the airport than the gas station based on the proximity of the airport to the user.

In particular embodiments, social-networking system 360 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 360 may provide information that is relevant to user's interests and current circumstances, increasing the likelihood that they will find such information of interest. In particular embodiments, social-networking system 360 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 360 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 360 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 370 (e.g., via an API or other communication channel), or from another suitable system. In response to the request, social-networking system 360 may calculate the coefficient (or access the coefficient information if it has previously been calculated and stored). In particular embodiments, social-networking system 360 may measure an affinity with respect to a particular process. Different processes (both internal and external to the online social network) may request a coefficient for a particular object or set of objects. Social-networking system 360 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 32 Dec. 2010, U.S. patent application Ser. No. 12/978,265, filed 33 Dec. 2010, and U.S. patent application Ser. No. 13/632,869, filed 1 Oct. 2012, each of which is incorporated by reference.

In particular embodiments, one or more objects (e.g., content or other types of objects) of a computing system may be associated with one or more privacy settings. The one or more objects may be stored on or otherwise associated with any suitable computing system or application, such as, for example, a social-networking system 360, a client system 330, a third-party system 370, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node 404 corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 360 or shared with other systems (e.g., a third-party system 370). Although this disclosure describes using particular privacy settings in a particular manner, this disclosure contemplates using any suitable privacy settings in any suitable manner.

In particular embodiments, privacy settings may be based on one or more nodes or edges of a social graph 400. A privacy setting may be specified for one or more edges 306 or edge-types of the social graph 400, or with respect to one or more nodes 402, 404 or node-types of the social graph 400. The privacy settings applied to a particular edge 406 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 360. The object may be associated with a concept node 404 connected to a user node 402 of the first user by an edge 406. The first user may specify privacy settings that apply to a particular edge 406 connecting to the concept node 404 of the object or may specify privacy settings that apply to all edges 406 connecting to the concept node 404. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 360 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 360 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 370, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 362 may be authorization/privacy servers for enforcing privacy settings. In response to a request from a user (or other entity) for a particular object stored in a data store 364, the social-networking system 360 may send a request to the data store 364 for the object. The request may identify the user associated with the request and the object may be sent only to the user (or a client system 330 of the user) if the authorization server determines that the user is authorized to access the object based on the privacy settings associated with the object. If the requesting user is not authorized to access the object, the authorization server may prevent the requested object from being retrieved from the data store 364 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user or may be the particular user's account or information stored on the social-networking system 360, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 360 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 360 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 360 may access such information in order to provide a particular function or service to the first user, without the social-networking system 360 having access to that information for any other purposes. Before accessing, storing, or using such objects or information, the social-networking system 360 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 360.

In particular embodiments, a user may specify whether particular types of objects or information associated with the first user may be accessed, stored, or used by the social-networking system 360. As an example and not by way of limitation, the first user may specify that images sent by the first user through the social-networking system 360 may not be stored by the social-networking system 360. As another example and not by way of limitation, a first user may specify that messages sent from the first user to a particular second user may not be stored by the social-networking system 360. As yet another example and not by way of limitation, a first user may specify that all objects sent via a particular application may be saved by the social-networking system 360.

In particular embodiments, privacy settings may allow a first user to specify whether particular objects or information associated with the first user may be accessed from particular client systems 330 or third-party systems 370. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 360 may provide default privacy settings with respect to each device, system, or application, and/or the first user may be prompted to specify a particular privacy setting for each context. As an example and not by way of limitation, the first user may utilize a location-services feature of the social-networking system 360 to provide recommendations for restaurants or other places in proximity to the user. The first user's default privacy settings may specify that the social-networking system 360 may use location information provided from a client device 330 of the first user to provide the location-based services, but that the social-networking system 360 may not store the location information of the first user or provide it to any third-party system 370. The first user may then update the privacy settings to allow location information to be used by a third-party image-sharing application in order to geo-tag photos.

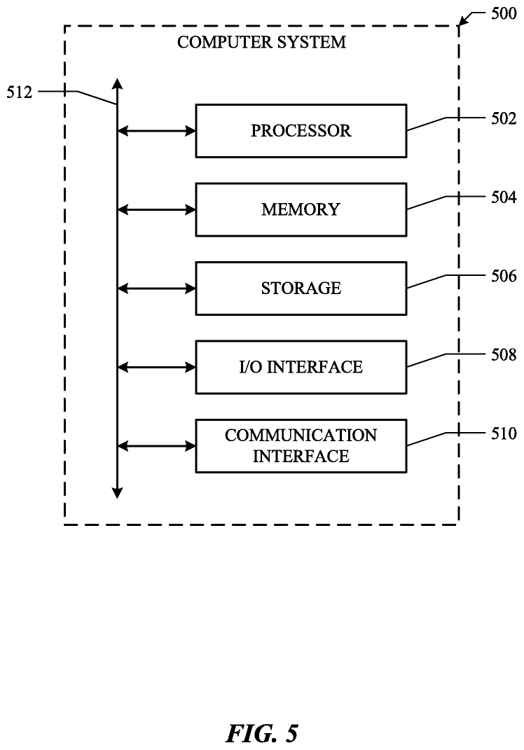

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing system, receiving location reports over a specified period of time indicating locations of mobile devices associated with users of an internet platform;
by the computing system, registering a count for each location report received from a mobile device indicating a location of the mobile device;
by the computing system, determining, for each location report received from a mobile device, a recent location report received from the mobile device indicating a previous location;
by the computing system, registering a transition for each of a paired location report and recent location report, corresponding to a pair of locations;
by the computing system, counting a number of transitions corresponding to a particular pair of locations;
by the computing system, determining common transitions by comparing the number of transitions corresponding to a particular pair of locations to a threshold value;
by the computing system, receiving a location report indicating the current location of a subject user's mobile device;
by the computing system, comparing the location report indicating the current location of the subject user's mobile device with location reports included in common transitions; and
by the computing system, predicting, based on a comparison between the location report indicating the current location of the subject user's mobile device and the location reports included in at least one common transition, a likelihood that the subject user will arrive at a particular place within a particular time period or a likelihood that the subject user was at a particular place within a particular time period before the current time.

2. The method of claim 1, wherein a location report or location reports include data corresponding to values for longitude, latitude, and a timestamp.

3. The method of claim 1, further comprising the step of determining, by the computing system, at least one periodic pattern.

4. The method of claim 1, wherein a location report or location reports include data corresponding to at least one of the name of a business establishment, a street address, a school, a landmark, or a transportation system.

5. The method of claim 1, further comprising the steps of:
by the computing system, determining an advertisement of relevance to the particular place where the subject user is predicted to arrive within the particular time period; and
by the computing system, communicating the advertisement to the mobile device of the subject user.

6. The method of claim 1, further comprising the steps of:
by the computing system, receiving information relevant to the particular place where the subject user is predicted to arrive within the particular time period; and
by the computing system, communicating to the subject user's mobile device, the information relevant to the particular place where the subject user is predicted to arrive within the particular time period.

7. The method of claim 1, further comprising the steps of:
by the computing system, determining an advertisement of relevance to the particular place where the subject user is predicted to have been within the particular time period before the current time; and
by the computing system, communicating the advertisement to the mobile device of the subject user.

8. The method of claim 1, further comprising the steps of:
by the computing system, receiving information relevant to the particular place where the subject user is predicted to have been within the particular time period; and
by the computing system, communicating to the subject user's mobile device, the information relevant to the particular place where the subject user is predicted to have been within a particular time period before the current time.

9. A system comprising:
a receiver configured to:
receive location reports over a specified period of time indicating locations of mobile devices associated with users of an internet platform;
a processor, coupled to the receiver, configured to:
register a count for each location report received from a mobile device indicating a location of a mobile device;
determine, for each location report received from a mobile device, a recent location report received from the mobile device indicating a previous location;
register a transition for each of a paired location report and recent location report, corresponding to a pair of locations;
count a number of transitions corresponding to a particular pair of locations;
determine common transitions by comparing the number of transitions corresponding to a particular pair of locations to a threshold value;
the receiver being further configured to receive a location report indicating the current location of a subject user's mobile device;
the processor being further configured to:
compare the location report indicating a current location of a subject user's mobile device with location reports included in common transitions; and
predict, based on a comparison between the location report indicating the current location of a subject user's mobile device and the location reports included in at least one common transition, a likelihood that the subject user will arrive at a particular place within a particular time period or a likelihood that the subject user was at a particular place within a particular time period before the current time.

10. The system of claim 9, wherein a location report or location reports include data corresponding to values for longitude, latitude, and a timestamp.

11. The system of claim 9, further comprising the step of determining, by the computing system, at least one periodic pattern.

12. The system of claim 9, wherein a location report or location reports include data corresponding to at least one of the name of a business establishment, a street address, a school, a landmark, or a transportation system.

13. The system of claim 9, wherein the processor is further configured to:
determine an advertisement of relevance to the particular place where the subject user is predicted to arrive within a particular time period; and
communicate the advertisement to the mobile device of the subject user.

14. The system of claim 9, wherein the processor is further configured to:
receive information relevant to the particular place where the subject user is predicted to arrive within a particular time period; and
communicate to the subject user's mobile device, the information relevant to the particular place where the subject user is predicted to arrive within a particular time period.

15. The system of claim 9, wherein the processor is further configured to:
determine an advertisement of relevance to the particular place where the subject user is predicted to have been within a particular time period before the current time; and
communicate the advertisement to the mobile device of the subject user.

16. The system of claim 9, wherein the processor is further configured to:
receive information relevant to the particular place where the subject user is predicted to have been within a particular time period; and
communicate to the subject user's mobile device, the information relevant to the particular place where the subject user is predicted to have been within a particular time period before the current time.

17. One or more computer-readable non-transitory storage media embodying software that is operable when executed to:
receive location reports over a specified period of time indicating locations of mobile devices associated with users of an internet platform;
register a count for each location report received from a mobile device indicating a location of a mobile device;
determine, for each location report received from a mobile device, a recent location report received from the mobile device indicating a previous location;
register a transition for each of a paired location report and recent location report, corresponding to a pair of locations;
count a number of transitions corresponding to a particular pair of locations;
determine common transitions by comparing the number of transitions corresponding to a particular pair of locations to a threshold value;
receive a location report indicating the current location of a subject user's mobile device;
compare the location report indicating a current location of a subject user's mobile device with location reports included in common transitions; and
predict, based on a comparison between the location report indicating the current location of a subject user's mobile device and the location reports included in at least one common transition, a likelihood that the subject user will arrive at a particular place within a particular time period or a likelihood that the subject user was at a particular place within a particular time period before the current time.
